(19) United States
(12) Patent Application Publication
(10) Pub. No.: US 2006/0221113 A1
(43) Pub. Date: Oct. 5, 2006

(54) System and method for printhead management

(76) Inventors: Robert F. Little, Escondido, CA (US); Srinivas Bhakthavatsalam, San Diego, CA (US); Ming Chen, Singapore (SG); Antoni Murcia, San Diego, CA (US); Dave Berardelli, San Diego, CA (US); Josep-Maria Serra, San Diego, CA (US); Vladimir Pavlov, San Diego, CA (US); Neil Doherty, San Diego, CA (US); Robert Fogarty, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/096,123

(22) Filed: Mar. 31, 2005

(51) Int. Cl. B41J 29/393

(52) U.S. Cl. 347/19

(57) ABSTRACT

A method performed by an inkjet printing system is provided. The method comprises detecting an amount of use of a printhead and providing a request to service the printhead to a user in response to detecting the amount of use.

### BACKGROUND

An inkjet printing system may include a printhead and an ink supply which supplies liquid ink to the printhead. The printhead ejects ink drops through a plurality of orifices and toward a print medium, such as a sheet of paper, so as to print onto the print medium. Typically, the orifices are arranged in one or more arrays such that properly sequenced ejection of ink from the orifices causes characters or other images to be printed upon the print medium as the printhead and the print medium are moved relative to each other.

At times, ink may build up on or near the orifices of a printhead and cause the print quality to decrease. When ink builds up, a printhead may be serviced to remove the ink around the orifices. It would be desirable to be able to service a printhead at appropriate times to prevent the print quality of the printhead from decreasing.

### BRIEF DESCRIPTION OF THE DRAWINGS

FIG. 1 is a block diagram illustrating one embodiment of an inkjet printing system.

FIG. 2 is a schematic diagram illustrating one embodiment of a portion of a continuous web print medium.

FIGS. 3A-3C are a flow chart illustrating one embodiment of a method performed by a printhead assembly.

FIGS. 4A-4C are a flow chart illustrating one embodiment of a method for operating a printhead assembly.

FIG. 5 is a flow chart illustrating one embodiment of a method for performing a power on service.

FIG. 6 is a flow chart illustrating one embodiment of a method for performing a beginning of job service.

FIG. 7 is a flow chart illustrating one embodiment of a method for performing a middle of job service.

FIG. 8 is a flow chart illustrating one embodiment of a method for performing an end of job service.

FIG. 9 is a flow chart illustrating one embodiment of a method for performing a printhead align service.

FIG. 10 is a flow chart illustrating one embodiment of a method for performing a printhead recovery service.

FIG. 11 is a flow chart illustrating one embodiment of a method for performing a printhead replace service.

FIG. 12 is a flow chart illustrating one embodiment of a method for performing a manual wipe service.

### DETAILED DESCRIPTION

In the following detailed description of the preferred embodiments, reference is made to the accompanying drawings, which form a part hereof, and in which is shown by way of illustration specific embodiments in which the present disclosure may be practiced. It is to be understood that other embodiments may be utilized and structural or logical changes may be made without departing from the scope of the present disclosure. The following detailed description, therefore, is not to be taken in a limiting sense.

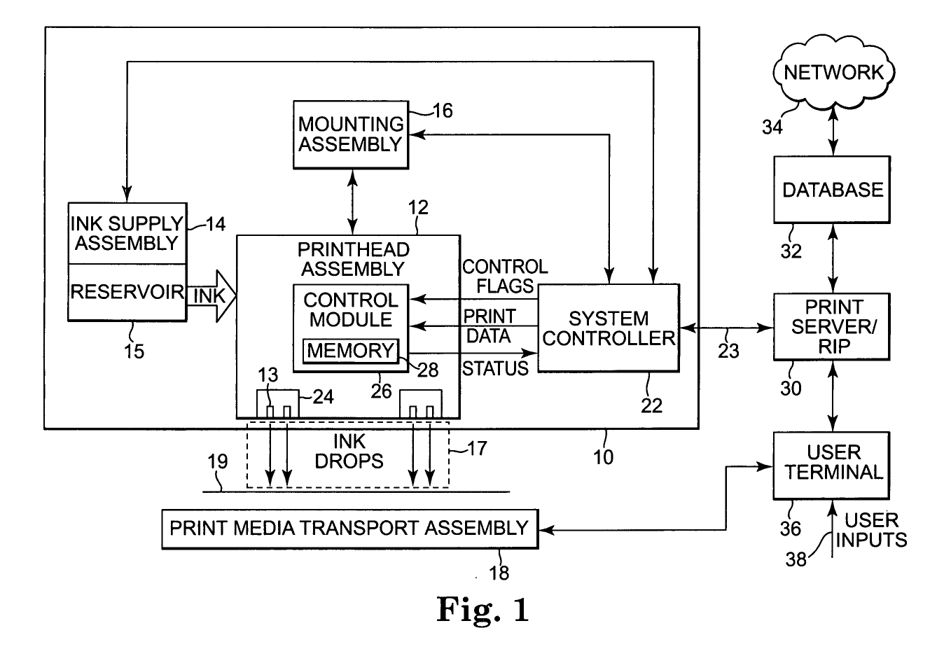

FIG. 1 illustrates one embodiment of an inkjet printing system 10 as an example of an image forming system. Inkjet printing system 10 includes an inkjet printhead assembly 12, an ink supply assembly 14, a mounting assembly 16, and a system controller 22.

In one embodiment, inkjet printhead assembly 12 includes one or more printheads 24 which eject drops of ink through a plurality of orifices or nozzles 13 and toward an embodiment of media, such as print medium 19, so as to print onto print medium 19. Inkjet printhead assembly 12 also includes a control module 26 with a memory 28.

Print medium 19 includes any type of suitable sheet material, such as paper, cardstock, transparencies, Mylar, cloth, and the like. Typically, nozzles 13 are arranged in one or more columns or arrays such that properly sequenced ejection of ink from nozzles 13 causes characters, symbols, and/or other graphics or images to be printed upon print medium 19 as inkjet printhead assembly 12 and print medium 19 are moved relative to each other.

Ink supply assembly 14 supplies ink to inkjet printhead assembly 12 and includes a reservoir 15 for storing ink. As such, ink flows from reservoir 15 to inkjet printhead assembly 12. In one embodiment, inkjet printhead assembly 12 and ink supply assembly 14 are housed together to form an inkjet cartridge or pen. In another embodiment, ink supply assembly 14 is separate from inkjet printhead assembly 12 and supplies ink to inkjet printhead assembly 12 through an interface connection, such as a supply tube. In either embodiment, reservoir 15 of ink supply assembly 14 may be removed, replaced, and/or refilled.

Mounting assembly 16 supports inkjet printhead assembly 12 relative to a print media transport assembly 18 controlled by a user terminal 36. Print media transport assembly 18 positions print medium 19 relative to inkjet printhead assembly 12. Thus, a print area 17 is defined adjacent to nozzles 13 in an area between inkjet printhead assembly 12 and print medium 19. In one embodiment, inkjet printhead assembly 12 is a non-scanning or fixed printhead assembly. As such, mounting assembly 16 fixes inkjet printhead assembly 12 at a prescribed position relative to print media transport assembly 18. Thus, print media transport assembly 18 advances or positions print medium 19 relative to inkjet printhead assembly 12.

System controller 22 communicates with control module 26 of inkjet printhead assembly 12, ink supply assembly 14, and mounting assembly 16. System controller 22 provides control flags and print data to printhead assembly 12. System controller 22 receives data 23 from a print server/raster image processor (RIP) 30 and includes memory (not shown) for temporarily storing data 23. Typically, data 23 is sent to inkjet printing system 10 along an electronic, infrared, optical or other information transfer path. In one embodiment, data 23 is sent along a gigabit Ethernet connection. Data 23 represents, for example, a document and/or file to be printed. As such, data 23 forms a print job for inkjet printing system 10 and includes one or more print job commands and/or command parameters. System controller 22 communicates with inkjet supply assembly 14 to cause ink in reservoir 15 to be pressurized and de-pressurized and to monitor the ink levels in reservoir 15.

Control module 26 is configured to control the operation of printhead assembly 12 in response to commands from system controller 22 using information in memory 28. In one embodiment, control module 26 provides control of inkjet printhead assembly 12 including timing control for ejection of ink drops from nozzles 13. As such, control module 26 defines a pattern of ejected ink drops which form characters, symbols, and/or other graphics or images on print medium 19 according to print data received from system controller 22. Control module 26 comprises any combination of hardware and software components, such as a processing system and firmware, configured to perform the functions of control module 26 described below. Any software components may be stored on a computer readable medium (not shown) accessible to a computer or other processing system prior to being stored in memory 28.

In one embodiment, print server 30 accesses print jobs from a database 32 in response to user inputs 38 provided to a user terminal 36 coupled to print server 30. The print jobs are provided to database 32 from any suitable processing system using a network 34. Network 34 may be any suitable LAN, WAN, or global communication network. User terminal 36 controls the speed of media 19 relative to inkjet printing system 10 by controlling print media transport assembly 18.

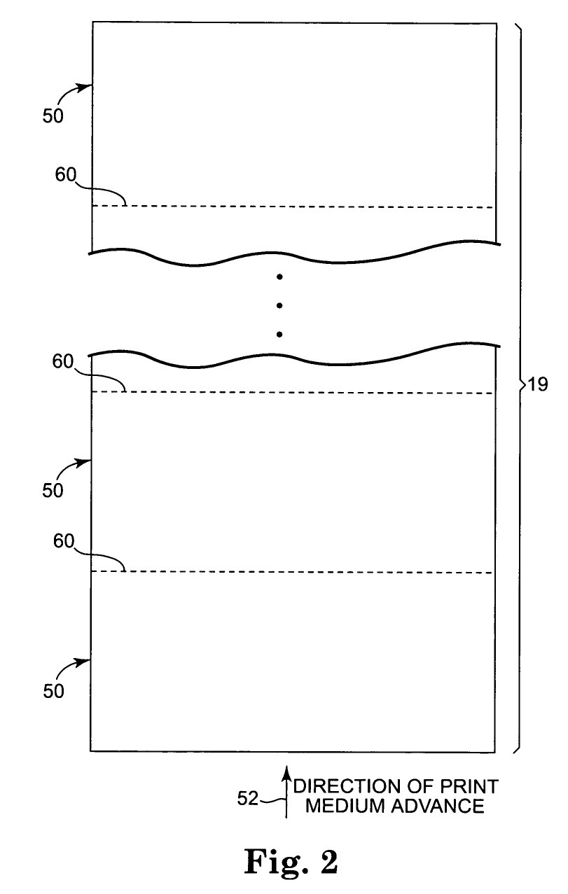

In one embodiment, as illustrated in FIG. 2, print medium 19 is a continuous form or continuous web print medium 19. As such, print medium 19 may include a plurality of continuous print medium sections 50. Print medium sections 50 represent, for example, individual sheets, forms, labels, or the like which may be physically separated from each other by cutting or tearing along, for example, perforated lines 60. In addition, print medium 19 may include a continuous roll of unprinted paper with print medium sections 50 individually delineated by indicia, openings, or other markings. Since inkjet printhead assembly 12 is fixed, print medium 19 moves relative to inkjet printhead assembly 12 during printing. More specifically, print medium 19 is advanced relative to inkjet printhead assembly 12 in a direction indicated by an arrow 52.

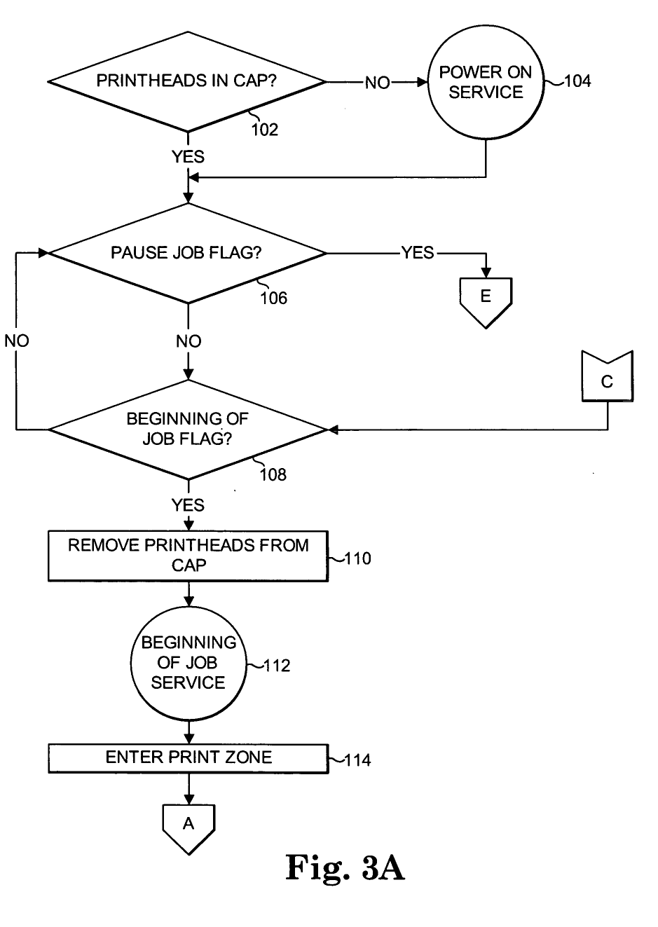

In the process of printing to medium 19, printheads 24 apply energy to resistor elements adjacent to nozzles 13 to heat ink to the boiling point of the ink to cause a vapor bubble to form and push ink out of nozzles 13 onto medium 19. As printheads 24 continue to print, ink may build up on printheads 24 such that it would be desirable to service printheads 24 to maintain print quality. System controller 22 and control module 26 operate to control the servicing of printheads 24 before, during, and after a print job. The operation of system controller 22 and control module 26 is described below with reference to the embodiments of FIGS. 3A-12.

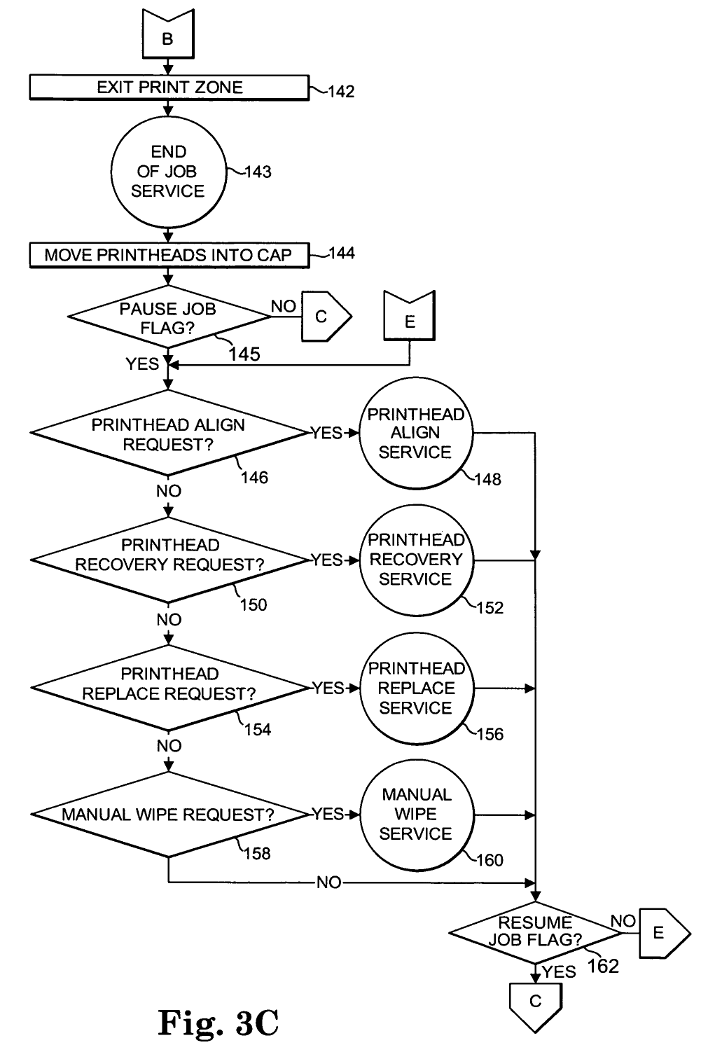

FIGS. 3A-3C are a flow chart illustrating one embodiment of the method performed by control module 26 of printhead assembly 12. The method of FIGS. 3A-3C may be initiated in response to inkjet printing system 10 being powered on. In FIG. 3A, a determination is made by control module 26 as to whether printheads 24 are in a cap (not shown) that covers each printhead 24 prior to being powered on as indicated in a block 102. If printheads 24 are not in the cap when inkjet printing system 10 is powered on, then control module 26 causes a power on service to be performed as indicated in a block 104. If printheads 24 are not in the cap, then inkjet printing system 10 may have lost power during a print job and ink may have built up on printheads 24 and printheads 24 are serviced at startup when the power is turned on. The power on service is described in additional detail below with reference to FIG. 5.

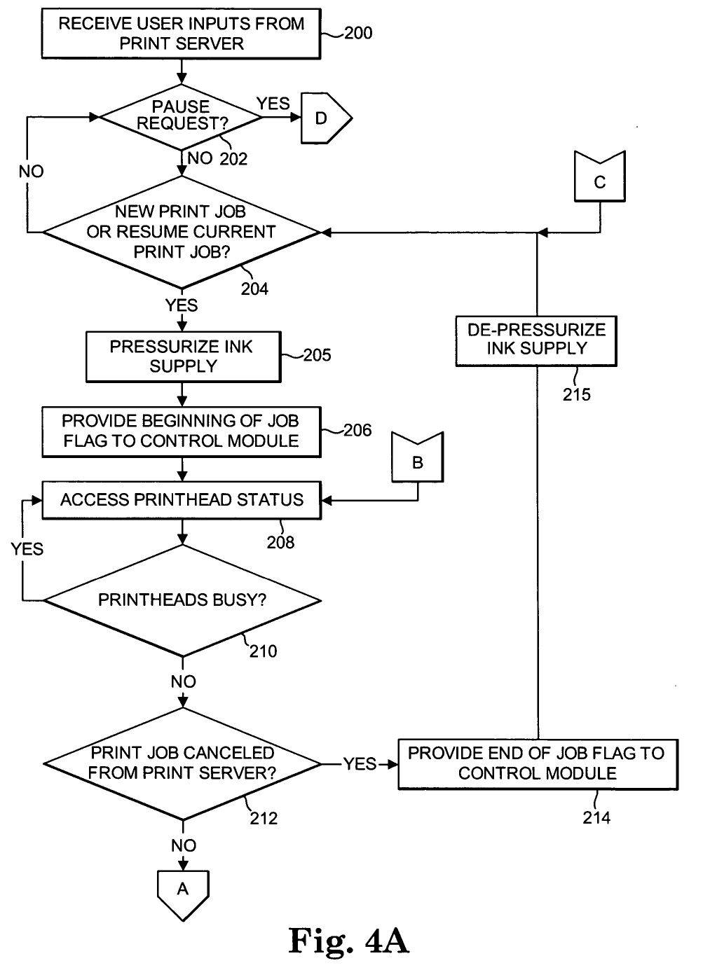

A determination is made by control module 26 as to whether a pause job flag has been received from system controller 22 as indicated in a block 106. If a pause job flag has been received, then the method continues at point E in FIG. 3C as described below. If a pause job flag has not been received, then a determination is made by control module 26 as to whether a beginning of job flag has been received from system controller 22 as indicated in a block 108. If a beginning of job flag has not been received, then the function of block 106 is repeated. If a beginning of job flag has been received, then control module 26 removes printheads 24 from the cap as indicated in a block 110. Control module 26 performs a beginning of job service on printheads 24 as indicated in a block 112. The beginning of job service is described in additional detail below with reference to FIG. 6. Subsequent to completing the beginning of job service, control module 26 enters a print zone as indicated in a block 114.

The method continues at point A in FIG. 3B. A determination is made by control module 26 as to whether a cancel job flag has been received from system controller 22 as indicated in a block 116. If a cancel job flag has been received, then the method continues at point B in FIG. 3C as described below.

If a cancel job flag has not been received, then a determination is made by control module 26 as to whether a pause job flag has been received from system controller 22 as indicated in a block 120. If a pause job flag has been received, then the method continues at point B in FIG. 3C as described below.

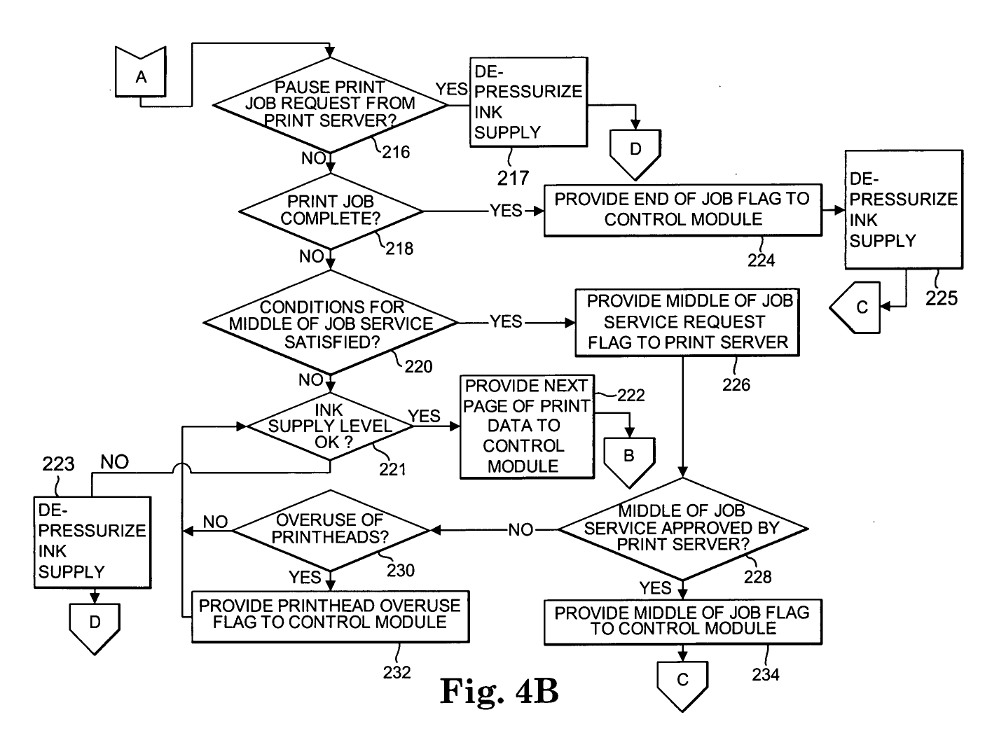

A determination is made by control module 26 as to whether a middle of job service flag has been received from system controller 22 as indicated in a block 122. If a middle of job service flag has been received, then control module 26 exits the print zone as indicated in a block 124. Control module 26 performs a middle of job service as indicated in a block 126. An embodiment of the middle of job service will be described below with reference to FIG. 7.

Subsequent to completing the middle of job service, control module 26 moves printheads 24 into the cap as indicated in a block 128. The method resumes at point C in FIG. 3A to repeat the function of block 108.

If a middle of job service flag has not been received, then a determination is made by control module 26 as to whether a printhead overuse flag has been received from system controller 22 as indicated in a block 130. If a printhead overuse flag has been received, then control module 26 records a failure to service printheads 24 as indicated in a block 132. In one embodiment, control module 26 records a failure to service printheads 24 on printhead acumens (not shown) or other memory.

Subsequent to block 132 or if printheads 24 have not been overused, a determination is made by control module 26 as to whether an end of job flag is received from system controller 22 as indicated in a block 134. If an end of job flag is received, then the method resumes at point B in FIG. 3C as described below.

If an end of job flag is not received, then control module 26 sets the status indicator to busy as indicated in a block 136. System controller 22 may withhold commands and additional print data from control module 26 in response to detecting that the status indicator is set to busy. Control module 26 causes printheads 24 to print page data in memory 28 as indicated in a block 138. Control module 26 sets the status indicator to idle as indicated in a block 140. System controller 22 may resume providing commands and additional print data to control module 26 in response to detecting that the status indicator is set to idle. The method returns to point A in FIG. 3B to repeat the function of block 116.

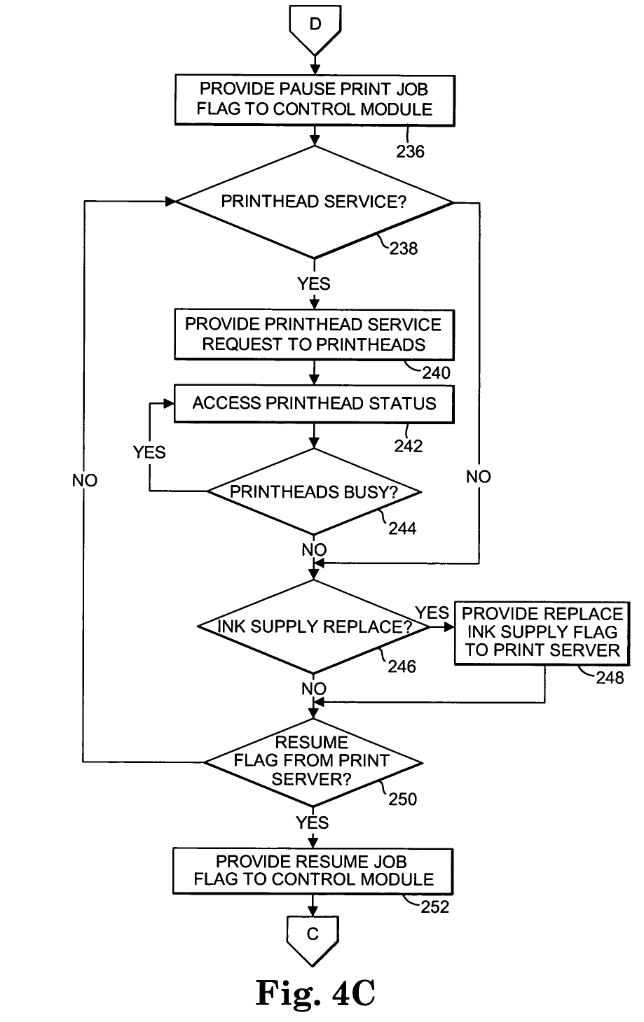

Referring to point B in FIG. 3C, if control module 26 determines that a cancel job flag has been received in block 116, or if control module 26 determines that a pause job flag has been received as determined in block 120, or if control module 26 determines that a end of job flag has been received as determined in block 134, then control module 26 exits the print zone as indicated in a block 142. Control module 26 performs an end of job service as indicated in a block 143. The end of job service will be described in additional detail below with reference to FIG. 8.

Subsequent to completing the end of job service, control module 26 moves printheads 24 into the cap as indicated in a block 144. A determination is made as to whether a pause job flag has been received from system controller 22 as indicated in a block 145. If a pause job flag has not been received, then the method returns to point C in FIG. 3A to repeat the function of block 108.

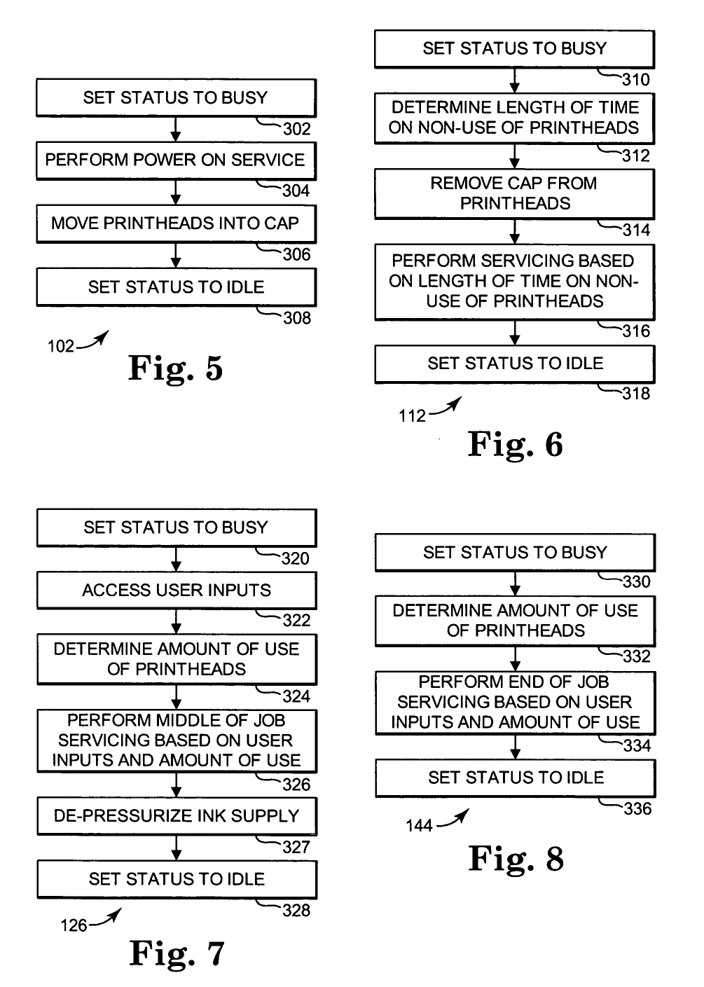

If a pause job flag has been received, then a determination is made as to whether a printhead align request is received as indicated in a block 146. If a printhead align request is received, then control module 26 performs a printhead align service as indicated in a block 148. The printhead align service will be described in additional detail below with reference to FIG. 9. Subsequent to completing the printhead align service, a determination is made as to whether a resume job flag has been received as indicated in a block 162. If a resume job flag has been received, then the method returns to point C in FIG. 3A to repeat the function of block 108. If a resume job flag has not been received, then the method returns to point E in FIG. 3C to repeat the function of block 146.

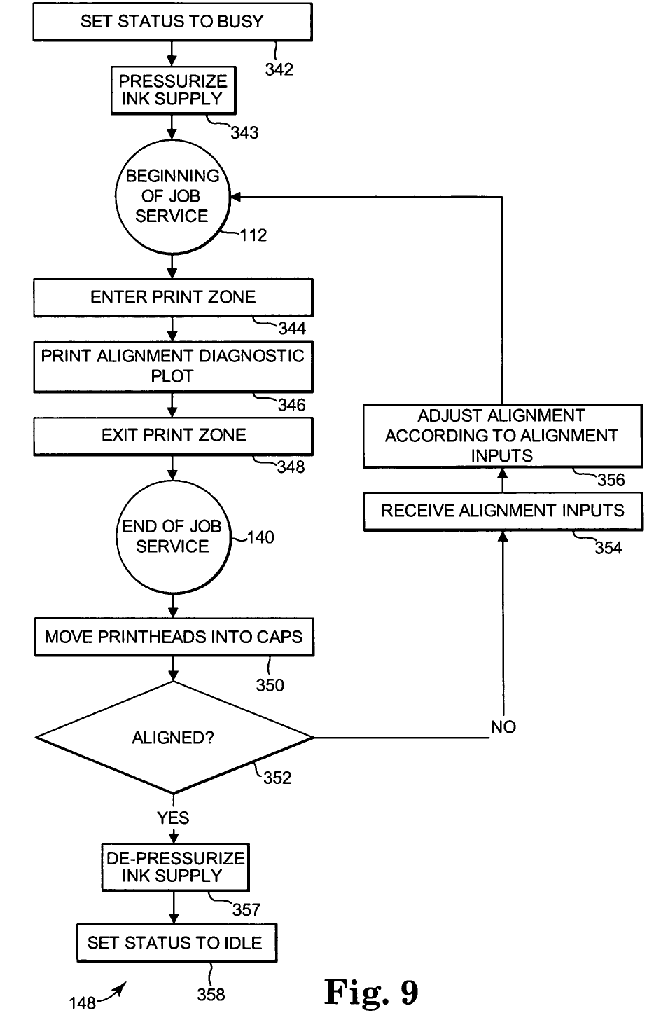

If a printhead align request is not received as determined in block 146, then a determination is made by control module 26 as to whether a printhead recovery request is received as indicated as a block 150. If a printhead recovery request is received, then control module 26 performs a printhead recovery service as indicated in a block 152. The printhead recovery service will be described in additional detail below with reference to FIG. 10. Subsequent to completing the printhead recovery service, a determination is made as to whether a resume job flag has been received as indicated in a block 162. If a resume job flag has been received, then the method returns to point C in FIG. 3A to repeat the function of block 108. If a resume job flag has not been received, then the method returns to point E in FIG. 3C to repeat the function of block 146.

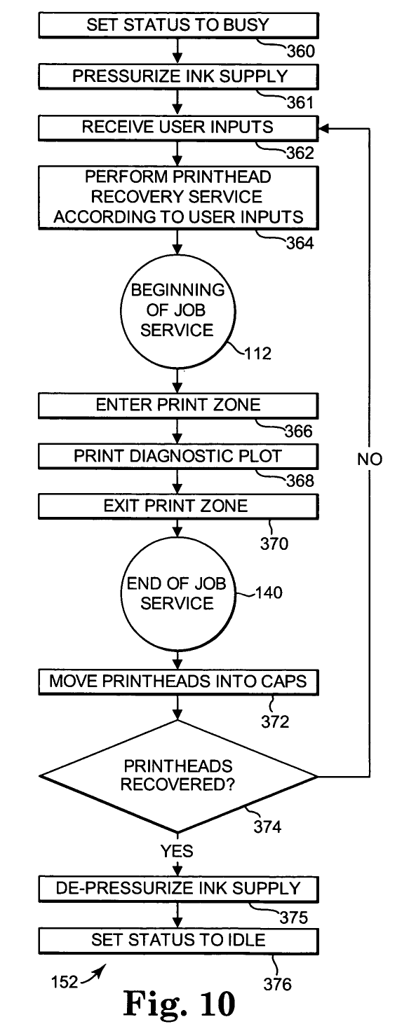

If a printhead recovery request is not received as determined in block 146, then a determination is made by control module 26 as to whether a printhead replace request has been received as indicated in a block 154. If a printhead replace request has been received, then control module 26 performs a printhead replace service as indicated in a block 156. The printhead replace service will be described in additional detail below with reference to FIG. 11. Subsequent to completing the printhead replace service, a determination is made as to whether a resume job flag has been received as indicated in a block 162. If a resume job flag has been received, then the method returns to point C in FIG. 3A to repeat the function of block 108. If a resume job flag has not been received, then the method returns to point E in FIG. 3C to repeat the function of block 146.

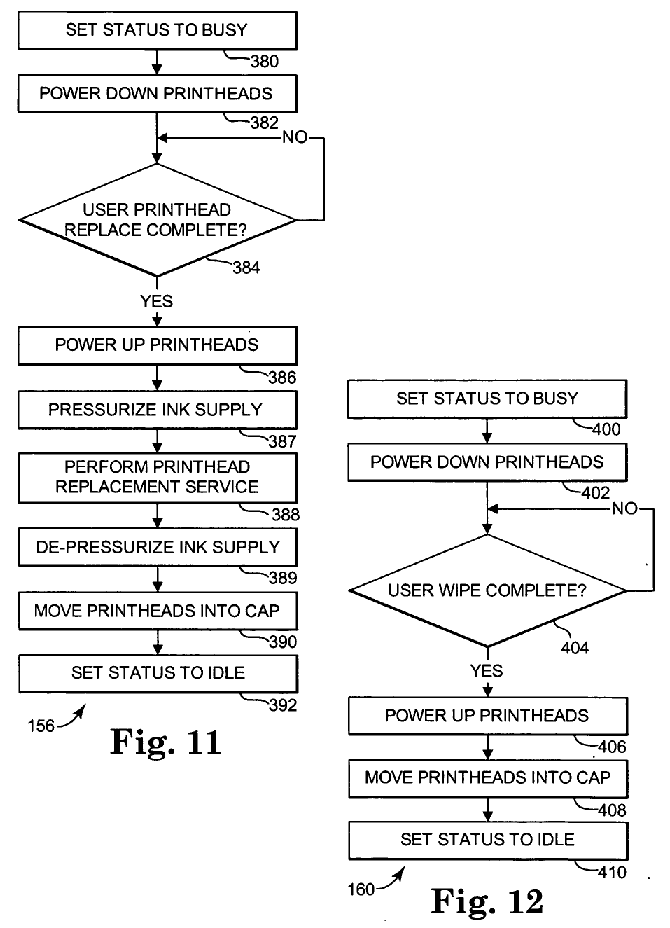

If a printhead replace request is not received, then a determination is made by control module 26 as to whether a manual wipe request has been received as indicated in a block 108. If a manual wipe request has been received, then control module 26 performs a manual wipe service as indicated in a block 160. Additional detail of the manual wipe service will be described with reference to FIG. 12 below. Subsequent to completing the manual wipe service or if a manual wipe request has not been received, a determination is made as to whether a resume job flag has been received as indicated in a block 162. If a resume job flag has been received, then the method returns to point C in FIG. 3A to repeat the function of block 108. If a resume job flag has not been received, then the method returns to point E in FIG. 3C to repeat the function of block 146.

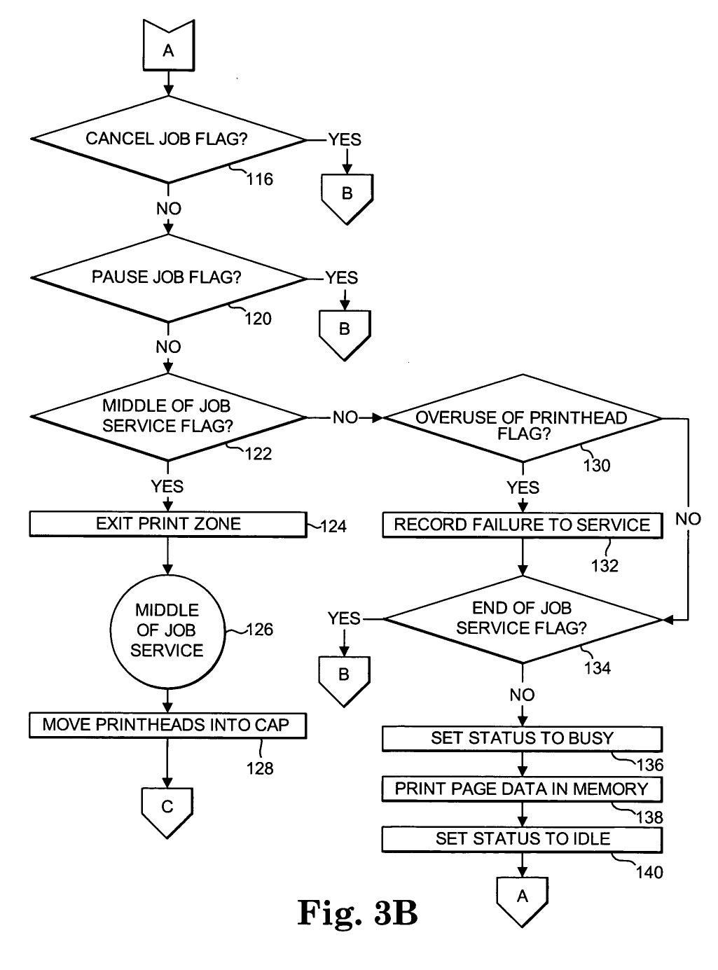

FIGS. 4A-4C are a flow chart illustrating one embodiment of a method of operating printhead assembly 12 with system controller 22. In FIG. 4A, system controller 22 receives user inputs 38 from print server 30 as indicated in a block 200. In one embodiment, system controller 22 causes print server 30 to prompt the user for user inputs 38 at user terminal 36. Print server 30 receives user inputs 38 from user terminal 36 and provides user inputs 38 to system controller 22. User inputs 38 specify the intensity (e.g., high, medium, and low) and frequency (e.g., high, medium, and low) for providing service to printheads 24 during a print job to be performed. The intensity indicates how much service to perform on printheads 24, and the frequency indicates how often to perform the service.

A determination is made by system controller 22 as to whether a pause request has been received from print server 30 as indicated in a block 202. If a pause request has been received from print server 30, then the method resumes at point D in FIG. 4C as described below.

If a pause request has not been received from print server 30, then a determination is made by system controller 22 as to whether a new print job is to be printed or a current print job is to be resumed as indicated in a block 204. System controller 22 repeats the function of block 202 and 204 until a print job is to be printed or resumed or a pause is requested. If a print job is to be printed or resumed then system controller 22 pressurizes ink supply assembly 14 as indicated in a block 205 and provides a beginning of job flag to control module 26 as indicated in a block 206. System controller 22 accesses the status indicator of printhead assembly 12 as indicated in a block 208. A determination is made by system controller 22 as to whether the status indicator indicates that printheads 24 are busy as indicated in a block 210. If the printheads are busy, then system controller 22 repeats the functions of blocks 208 and 210 until the status indicator indicates that printheads 24 are not busy, i.e., idle.

If the status indicator indicates that printheads 24 are not busy, then a determination is made by system controller 22 as to whether the print job is canceled from print server 30 as indicated in a block 212. In one embodiment, system controller 22 determines that the print job is canceled in response to receiving a cancel input provided to print server 30 from a user at user terminal 36. If the print job is canceled, then system controller 22 provides an end of job flag to control module 26 as indicated in a block 214, de-pressurizes ink supply assembly 14 as indicated in a block 215, and the method repeats the function of block 204.

If a print job is not canceled, then the method resumes at point A in FIG. 4B. A determination is made by system controller 22 as to whether a pause print job request is received from print server 30 as indicated in a block 212. If a pause print job request is received, then system controller 22 de-pressurizes ink supply assembly 14 as indicated in a block 217 and the method resumes at point D in FIG. 4C as described below.

If a pause print job request is not received, then a determination is made by system controller 22 as to whether the print job is complete as indicated in a block 218. If the print job is not complete, then system controller 22 determines whether conditions for a middle of job service are satisfied as indicated in a block 220. In one embodiment, the conditions for a middle of job service are set according to frequency of service indicated by the user inputs received in block 200. Using the frequency of service user input, system controller 22 determines that the conditions for a middle of job service are satisfied in response to detecting that an amount of use of inkjet printing system 10 (e.g., an amount of time of use, an amount of ink of ink supply 14 used, and/or a number of images or pages printed) has been exceeded.

If the conditions for a middle of job service are not satisfied, then a determination is made by system controller 22 as to whether the ink supply level of ink supply assembly 14 is okay as indicated in a block 221. If the ink supply level is okay, then system controller 22 provides a next page of print data to control module 26 for printing as indicated in a block 222. The method returns to point B in FIG. 4A to repeat the function of block 208.

If the print job is complete as determined in block 218, then system controller 22 provides an end of job flag to control module 26 as indicated in a block 224, and system controller 22 de-pressurizes ink supply assembly 14 as indicated in a block 225. The method resumes at point C in FIG. 4A as described below.

If the conditions for a middle of job service are satisfied, then system controller 22 provides a middle of job service request flag to print server 30 as indicated in a block 226. In response to receiving the middle of job service request flag, print server 30 causes a user of user terminal 36 to be prompted to approve the middle of job service. If the user approves, the user provides the approval to user terminal 36 which provides the approval to print server 30. Print server 30 provides the approval to system controller 22.

A determination is made by system controller 22 as to whether the middle of job service request has been approved by print server 30 as indicated in a block 228. If the middle of job service has not been approved, then a determination is made by system controller 22 as to whether printheads 24 have been overused as indicated in a block 230. In one embodiment, system controller 22 determines that printheads 24 have been overused in response to determining that a maximum amount of time or a maximum amount of use without servicing printheads 24 has been exceeded. If printheads 24 have been overused, then system controller 22 provides a printhead overuse flag to control module 26 as indicated in a block 232. If printheads 24 have not been overused, then the function of block 221 is repeated.

If the ink supply level is not okay, then system controller 22 de-pressurizes ink supply assembly 14 as indicated in a block 223 and the method resumes at point D in FIG. 4C as described below.

If the middle of job service has been approved, then system controller 22 provides a middle of job flag to control module 26 as indicated in a block 234. The method returns to point C in FIG. 4A to repeat the function of block 204.

Referring to point D in FIG. 4C, if a pause print job request is received from print server 30 as determined in block 216, then system controller 22 provides a pause print job flag to control module 26 as indicated in a block 236. A determination is made by system controller 22 as to whether to perform a printhead service as indicated in a block 238. If a printhead service is to be performed, then system controller 22 provides a printhead service request to control module 26 as indicated in a block 240. System controller 22 accesses a status indicator of printhead assembly 12 as indicated in a block 242. A determination is made by system controller 22 as to whether the printheads 24 are busy according to the status indicator as indicated in a block 244. If the printheads are busy, then the functions of blocks 242 and 244 are repeated.

If the printheads are not busy, then a determination is made as to whether the ink supply of ink supply assembly 14 should be replaced as indicated in a block 246. If the ink supply of ink supply assembly 14 should be replaced, then system controller 22 causes a replace ink supply flag to be provided to print server 30 which prompts the user at user terminal 36 to replace the ink supply as indicated in a block 248.

If the ink supply of ink supply assembly 14 should not be replaced, then a determination is made by system controller 22 as to whether a resume flag has been received from print server 30 as indicated in a block 250. If a resume flag has not been received from print server 30, then the function of block 238 is repeated. If a resume flag has been received from print server 30, then system controller 22 provides a resume job flag to control module 26 as indicated in a block 252. The method returns to point C in FIG. 4A to repeat the function of block 204.

FIG. 5 is a flow chart illustrating one embodiment of a method for performing a power on service by control module 26. In FIG. 5, control module 26 sets the status indicator to busy as indicated in a block 302. Control module 26 performs the power on service as indicated in a block 304. In one embodiment, control module 26 performs the power on service by causing printheads 24 to be wiped either automatically by a wiping apparatus in printheads 24 (not shown) or manually by a user. Control module 26 causes the printheads 24 to be moved into the cap as indicated in a block 306. Control module 26 sets the status indicator to idle as indicated in a block 308.

FIG. 6 is a flow chart illustrating one embodiment of a method for performing a beginning of job service by control module 26. In FIG. 6, control module 26 sets the status indicator to busy as indicated in a block 310. Control module 26 determines a length of time of non-use of printheads 24 as indicated in a block 312. Control module 26 causes the cap to be removed from printheads 24 as indicated in a block 314.

Control module 26 performs beginning of job servicing on printheads 24 based on the length of time of non-use of printheads 24 as indicated in a block 316. In one embodiment, control module 26 performs beginning of job servicing on printheads 24 by causing printheads 24 to spit a predetermined number of drops to purge nozzles 13, wipe printheads 24 using the wiping apparatus, and applying a chemical such as polyethylene glycol to dissolve ink on printheads 24 in a predetermined order.

In one embodiment, in response to detecting a low level of non-use, control module 26 performs servicing on printheads 24 by causing printheads 24 to spit 200 drops to purge nozzles 13. In response to detecting a lower moderate level of non-use, control module 26 performs servicing on printheads 24 by causing printheads 24 to spit 5000 drops to purge nozzles 13. In response to detecting a moderate or upper moderate level of non-use, control module 26 performs servicing on printheads 24 by causing printheads 24 to spit 100 drops to purge nozzles 13, wipe printheads 24 using the wiping apparatus, and spit 5000 drops to purge nozzles 13. In response to detecting a high level of non-use, control module 26 performs servicing on printheads 24 by causing printheads 24 to spit 200 drops to purge nozzles 13, applying polyethylene glycol to dissolve ink on printheads 24, wipe printheads 24 using the wiping apparatus, spit 1000 drops to purge nozzles 13, wipe printheads 24 using the wiping apparatus, and spit 3500 drops to purge nozzles 13.

Subsequent to performing the beginning of job servicing, control module 26 sets the status indicator to idle as indicated in a block 318.

FIG. 7 is a flow chart illustrating one embodiment of a method for performing a middle of job service by control module 26. In FIG. 7, control module 26 sets the status indicator to busy as indicated in a block 320. Control module 26 accesses user inputs received from system controller 22 as indicated in a block 322. Control module 26 determines an amount of use of printheads 24 as indicated in a block 324.

Control module 26 performs middle of job servicing on printheads 24 based on the amount of use of printheads 24 as indicated in a block 326. In one embodiment, control module 26 performs middle of job servicing on printheads 24 by causing printheads 24 to spit a predetermined number of drops to purge nozzles 13, wipe printheads 24 using the wiping apparatus, and applying a chemical such as polyethylene glycol to dissolve ink on printheads 24 in a predetermined order.

In one embodiment, in response to detecting a low amount of use of printheads 24, control module 26 performs middle of job servicing on printheads 24 by causing printheads 24 to spit 100 drops to purge nozzles 13, wipe printheads 24 using the wiping apparatus, and spit 500 drops to purge nozzles 13. In response to detecting a moderate amount of use of printheads 24, control module 26 performs middle of job servicing on printheads 24 by causing printheads 24 to spit 100 drops to purge nozzles 13, applying polyethylene glycol to dissolve ink on printheads 24, wipe printheads 24 using the wiping apparatus, spit 1000 drops to purge nozzles 13, wipe printheads 24 using the wiping apparatus, and spit 500 drops to purge nozzles 13. In response to detecting a high amount of use of printheads 24, control module 26 performs middle of job servicing on printheads 24 by causing printheads 24 to spit 200 drops to purge nozzles 13, applying polyethylene glycol to dissolve ink on printheads 24, wipe printheads 24 using the wiping apparatus, spit 3000 drops to purge nozzles 13, wipe printheads 24 using the wiping apparatus, spit 3000 drops to purge nozzles 13, wipe printheads 24 using the wiping apparatus, and spit 5000 drops to purge nozzles 13.

Subsequent to performing the middle of job servicing, system controller 22 de-pressurizes ink supply assembly 14 as indicated in a block 327. Control module 26 sets the status indicator to idle as indicated in a block 328.

FIG. 8 is a flow chart illustrating one embodiment of a method for performing an end of job service by control module 26. In FIG. 8, control module 26 sets the status indicator to busy as indicated in a block 330. Control module 26 determines an amount of use of printheads 24 as indicated in a block 332.

Control module 26 performs end of job servicing on printheads 24 based on the amount of use of printheads 24 as indicated in a block 334. In one embodiment, control module 26 performs end of job servicing on printheads 24 by causing printheads 24 to spit a predetermined number of drops to purge nozzles 13, wipe printheads 24 using the wiping apparatus, and applying a chemical such as polyethylene glycol to dissolve ink on printheads 24 in a predetermined order.

In one embodiment, in response to detecting a low amount of use of printheads 24, control module 26 performs end of job servicing on printheads 24 by causing printheads 24 to spit 100 drops to purge nozzles 13, wipe printheads 24 using the wiping apparatus, and spit 500 drops to purge nozzles 13. In response to detecting a moderate amount of use of printheads 24, control module 26 performs end of job servicing on printheads 24 by causing printheads 24 to spit 100 drops to purge nozzles 13, applying polyethylene glycol to dissolve ink on printheads 24, wipe printheads 24 using the wiping apparatus, spit 1000 drops to purge nozzles 13, wipe printheads 24 using the wiping apparatus, and spit 500 drops to purge nozzles 13. In response to detecting a high amount of use of printheads 24, control module 26 performs end of job servicing on printheads 24 by causing printheads 24 to spit 200 drops to purge nozzles 13, applying polyethylene glycol to dissolve ink on printheads 24, wipe printheads 24 using the wiping apparatus, spit 3000 drops to purge nozzles 13, wipe printheads 24 using the wiping apparatus, spit 3000 drops to purge nozzles 13, wipe printheads 24 using the wiping apparatus, and spit 5000 drops to purge nozzles 13.

Subsequent to performing the end of job servicing, control module 26 sets the status indicator to idle as indicated in a block 336.

FIG. 9 is a flow chart illustrating one embodiment of a method for performing a printhead align service by control module 26 and system controller 22. In FIG. 9, control module 26 sets the status indicator to busy as indicated in a block 342. System controller pressurizes ink supply assembly 14 as indicated in a block 343. Control module 26 performs a beginning of job service as indicated in block 112. The beginning of job service is described in additional detail above with reference to FIG. 7.

Control module 26 causes printheads 24 to enter the print zone as indicated in a block 344. Control module 26 prints an alignment diagnostic plot onto medium 19 using printheads 24 as indicated in a block 346. Control module 26 causes printheads 24 to exit the print zone as indicated in a block 348. Control module 26 performs an end of job service as indicated in block 140. The end of job service is described in additional detail above with reference to FIG. 8.

Control module 26 causes the printheads 24 to be moved into the cap as indicated in a block 350. A determination is made by control module 26 as to whether printheads 24 are aligned as indicated in a block 352. In one embodiment, control module 26 determines that printheads 24 are not aligned in response to receiving an input from system controller 22 where system controller 22 receives the input from a user via print server 30.

If printheads 24 are not aligned, then control module 26 receives alignment inputs as indicated in a block 354. In one embodiment, control module 26 receives the alignment inputs from system controller 22, and system controller 22 receives the alignment inputs from a user. Control module 26 adjusts the alignment of printheads 24 according to the alignment inputs as indicated in a block 356. If printheads 24 are aligned, then system controller de-pressurizes ink supply assembly 14 as indicated in a block 357. Control module 26 sets the status indicator to idle as indicated in a block 358.

FIG. 10 is a flow chart illustrating one embodiment of a method for performing a printhead recovery service by control module 26 and system controller 22. In FIG. 10, control module 26 sets the status indicator to busy as indicated in a block 360. System controller pressurizes ink supply assembly 14 as indicated in a block 361. Control module 26 receives user inputs from system controller 22 as indicated in a block 362. In one embodiment, the user inputs specify the intensity (e.g., high, medium, and low) for providing the printhead recovery service to printheads 24.

Control module 26 performs printhead recovery servicing on printheads 24 according to the user inputs as determined in block 364. In one embodiment, control module 26 performs printhead recovery servicing on printheads 24 by causing printheads 24 to spit a predetermined number of drops to purge nozzles 13, wipe printheads 24 using the wiping apparatus, and applying a chemical such as polyethylene glycol to dissolve ink on printheads 24 in a predetermined order.

In one embodiment, in response to detecting a low intensity user input for printheads 24, control module 26 performs end of job servicing on printheads 24 by causing printheads 24 to spit 200 drops to purge nozzles 13, applying polyethylene glycol to dissolve ink on printheads 24, wipe printheads 24 using the wiping apparatus, spit 3000 drops to purge nozzles 13, wipe printheads 24 using the wiping apparatus, spit 3000 drops to purge nozzles 13, wipe printheads 24 using the wiping apparatus, and spit 5000 drops to purge nozzles 13.

In response to detecting a medium intensity user input for printheads 24, control module 26 performs end of job servicing on printheads 24 by causing printheads 24 to spit 200 drops to purge nozzles 13, applying polyethylene glycol to dissolve ink on printheads 24, wipe printheads 24 using the wiping apparatus, spit 3000 drops to purge nozzles 13, scrub and wipe printheads 24 using the wiping apparatus, spit 3000 drops to purge nozzles 13, wipe printheads 24 using the wiping apparatus, and spit 5000 drops to purge nozzles 13.

In response to detecting a high intensity user input for printheads 24, control module 26 performs end of job servicing on printheads 24 by causing printheads 24 to spit 200 drops to purge nozzles 13, applying polyethylene glycol to dissolve ink on printheads 24, wipe printheads 24 using the wiping apparatus, spit 3000 drops to purge nozzles 13, scrub and wipe printheads 24 using the wiping apparatus, spit 3000 drops to purge nozzles 13, wipe printheads 24 using the wiping apparatus, and spit 5000 drops to purge nozzles 13.

Subsequent to performing the printhead recovery service, control module 26 performs a beginning of job service as indicated in block 112. The beginning of job service is described in additional detail above with reference to FIG. 7.

Control module 26 causes printheads 24 to enter the print zone as indicated in a block 366. Control module 26 prints an alignment diagnostic plot onto medium 19 using printheads 24 as indicated in a block 368. Control module 26 causes printheads 24 to exit the print zone as indicated in a block 370. Control module 26 performs an end of job service as indicated in block 140. The end of job service is described in additional detail above with reference to FIG. 8.

Control module 26 causes the printheads 24 to be moved into the cap as indicated in a block 372. A determination is made by control module 26 as to whether printheads 24 have been recovered as indicated in a block 374. If printheads 24 have not been recovered, then the method repeats the functions of blocks 364 through 374. After the printhead recovery servicing is complete, system controller de-pressurizes ink supply assembly 14 as indicated in a block 375. Control module 26 sets the status indicator to idle as indicated in a block 376.

FIG. 11 is a flow chart illustrating one embodiment of a method for performing a printhead replace service by control module 26 and system controller 22. In FIG. 11, control module 26 sets the status indicator to busy indicated in a block 382.

A determination is made by control module 26 as to whether the user has completed replacing one or more printheads 24 as indicated in a block 384. In one embodiment, control module 26 determines that the user has completed replacing one or more printheads 24 in response to receiving a signal from system controller 22 indicating that the user has completed replacing one or more printheads 24.

If the user has not completed replacing one or more printheads 24, then the function of block 384 is repeated until the user has completed replacing one or more printheads 24. After the user has completed replacing one or more printheads 24, control module 26 powers up printheads 24 as indicated in a block 386. System controller pressurizes ink supply assembly 14 as indicated in a block 387.

Control module 26 performs a printhead replacement service as indicated in a block 388. In one embodiment, control module 26 performs printhead replacement servicing on printheads 24 by causing printheads 24 to spit a predetermined number of drops to purge nozzles 13, wipe printheads 24 using the wiping apparatus, and applying a chemical such as polyethylene glycol to dissolve ink on printheads 24 in a predetermined order.

In one embodiment, control module 26 performs printhead replacement servicing on printheads 24 by causing printheads 24 to spit 2000 drops to purge nozzles 13, applying polyethylene glycol to dissolve ink on printheads 24, wipe printheads 24 using the wiping apparatus, applying polyethylene glycol to dissolve ink on printheads 24, wipe printheads 24 using the wiping apparatus, and spit 5000 drops to purge nozzles 13.

Subsequent to completing the printhead replacement servicing, system controller de-pressurizes ink supply assembly 14 as indicated in a block 389. Control module 26 causes printheads 24 to be moved into the cap as indicated in a block 390. Control module 26 sets the status indicator to idle as indicated in a block 392.

FIG. 12 is a flow chart illustrating one embodiment of a method for performing a manual wipe service by control module 26. In FIG. 12, control module 26 sets the status indicator to busy as indicated in a block 400. Control module 26 powers down printheads 24 as indicated in a block 402.

A determination is made by control module 26 as to whether the user has completed wiping one or more printheads 24 as indicated in a block 404. In one embodiment, control module 26 determines that the user has completed wiping one or more printheads 24 in response to receiving a signal from system controller 22 indicating that the user has completed wiping one or more printheads 24.

If the user has not completed wiping one or more printheads 24, then the function of block 404 is repeated until the user has completed replacing one or more printheads 24. After the user has completed replacing one or more printheads 24, control module 26 powers up printheads 24 as indicated in a block 406. Control module 26 causes printheads 24 to be moved into the cap as indicated in a block 408. Control module 26 sets the status indicator to idle as indicated in a block 410.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present disclosure. Those with skill in the optical, mechanical, electro-mechanical, electrical, and computer arts will readily appreciate that the present disclosure may be implemented in a very wide variety of embodiments. This application is intended to cover any adaptations or variations of the preferred embodiments discussed herein. Therefore, it is manifestly intended that this disclosure be limited only by the claims and the equivalents thereof.

What is claimed is:

1. A method performed by an inkjet printing system, the method comprising:
detecting an amount of use of a printhead; and
providing a request to service the printhead to a user in response to detecting the amount of use.

2. The method of claim 1 further comprising:
providing the request to service the printhead to the system controller during a print job.

3. The method of claim 1 further comprising:
receiving an approval associated with the request from the user; and
servicing the printhead in response to receiving the approval.

4. The method of claim 3 further comprising:
receiving a user input associated with servicing the printhead; and
servicing the printhead in accordance with the user input.

5. The method of claim 4 wherein the user input specifies an intensity of service to be performed on the printhead.

6. The method of claim 3 further comprising:
servicing the printhead by causing the printhead to spit a predetermined number of drops.

7. The method of claim 3 further comprising:
servicing the printhead by applying a chemical to dissolve ink on the printhead.

8. The method of claim 3 further comprising:
servicing the printhead by causing the printhead to be wiped.

9. The method of claim 1 further comprising:
receiving a user input associated with servicing the printhead; and
providing the request to service the printhead to the user in accordance with the user input.

10. The method of claim 9 wherein the user input specifies a frequency of service to be performed on the printhead.

11. An inkjet printing system comprising:
a printhead; and
a system controller configured to provide a first request to service the printhead to a user and service the printhead in response to receiving an approval associated with the first request from the system controller.

12. The inkjet printing system of claim 11 wherein the system controller is configured to provide the first request to service the printhead to the system controller during a print job.

13. The inkjet printing system of claim 11 wherein the system controller is configured to cause a status indicator to be set to a first value prior to servicing the printhead.

14. The inkjet printing system of claim 13 wherein the system controller is configured to cause the status indicator to be set to a second value subsequent to servicing the printhead.

15. The inkjet printing system of claim 13 wherein the system controller is configured to record a failure to service the printhead in response to not receiving the approval from the user for at least one of a predetermined time period and a printhead usage.

16. The inkjet printing system of claim 11 wherein the system controller is configured to receive a user input associated with servicing the printhead and wherein the system controller is configured to provide the first request to service the printhead to the user in accordance with the user input.

17. The inkjet printing system of claim 11 wherein the system controller is configured to receive a user input associated with servicing the printhead and wherein the system controller is configured to service the printhead in accordance with the user input.

18. The inkjet printing system of claim 11 wherein the system controller is configured to receive a second request to service the printhead from the user, wherein the system controller is configured to cause a status indicator to be set to a first value prior to causing service associated with the second request to be performed, and wherein the system controller is configured to cause the status indicator to be set to a second value subsequent to causing the service associated with the second request to be performed.

19. An image forming system comprising:
a printhead assembly including at least one printhead and a control module; and
a system controller;
wherein the system controller is configured to provide a request to service the printhead to a user during a print job, wherein the system controller is configured to provide a signal associated with the request to the control module, and wherein the control module is configured to service the printhead in response to receiving the signal from the system controller.

20. The image forming system of claim 19 wherein the control module is configured to set a status indicator to a first value prior to causing the control module to service the printhead.

21. The image forming system of claim 20 wherein the control module is configured to set the status indicator to a second value subsequent to causing the control module to service the printhead.

22. The image forming system of claim 19 wherein the system controller is configured to receive a user input from a user, and wherein the system controller is configured to provide the request to service the printhead to the user in accordance with the user input.

23. The image forming system of claim 19 wherein the system controller is configured to receive a user input from a user, and wherein the control module is configured to service the printhead in accordance with the user input in response to receiving the signal from the system controller.

24. A printhead assembly comprising:
means for detecting an amount of use of a printhead in the printhead assembly during a print job; and
means for providing a request to service the printhead to a user during the print job in response to detecting the amount of use.

25. The printhead assembly of claim 24 further comprising:
means for receiving a signal associated with the request; and
means for servicing the printhead in response to receiving the signal.

26. The printhead assembly of claim 25 further comprising:
means for setting a status indicator to a first value prior to servicing the printhead; and
means for setting the status indicator to a second value subsequent to servicing the printhead.

27. The printhead assembly of claim 24 further comprising:
means for receiving a user input associated with servicing the printhead; and
means for servicing the printhead in accordance with the user input.

28. The printhead assembly of claim 24 further comprising:
means for receiving a user input associated with servicing the printhead; and
means for providing the request to service the printhead to the user in accordance with the user input.

29. A computer readable medium having instructions for causing a processing system to execute a method comprising:
providing a request to service a printhead to a user during a print job; and
causing the printhead to be serviced in response to receiving a signal associated with the request.

30. The computer readable medium of claim 29 having instructions for causing the processing system to execute the method comprising:
setting a status indicator to a first value prior to causing the printhead to be serviced; and
setting the status indicator to a second value subsequent to causing the printhead to be serviced.
